(19) United States
(12) Patent Application Publication
(10) Pub. No.: US 2013/0291370 A1
(43) Pub. Date: Nov. 7, 2013

(54) METHOD FOR PRODUCING AN EARPIECE WITH A VENT

(71) Applicant: SIEMENS MEDICAL INSTRUMENTS PTE. LTD., SINGAPORE (SG)

(72) Inventor: ARTEM BOLTYENKOV, NUERNBERG (DE)

(21) Appl. No.: 13/886,417

(22) Filed: May 3, 2013

(30) Foreign Application Priority Data
May 3, 2012 (DE) 10 2012 207 316.7

(51) Int. Cl. H04R 31/00

(52) U.S. Cl. CPC H04R 31/00
USPC 29/594

(57) ABSTRACT

The production of an earpiece for a hearing apparatus and in particular for a hearing device is closely tailored to the simulation. To this end, the earpiece of a hearing apparatus to be inserted into an auditory canal is produced by first selecting a virtual raw vent and manufacturing the earpiece with a real vent. A base frequency of the acoustic transmission function of the virtual raw vent is determined. From that, a virtual vent is determined as a function of the base frequency and of at least one predetermined property of the auditory canal or of the earpiece. The earpiece is then manufactured on the basis of the virtual vent.

### CROSS-REFERENCE TO RELATED APPLICATION

This application claims the priority, under 35 U.S.C. §119, of German application DE 10 2012 207 316.7, filed May 3, 2012; the prior application is herewith incorporated by reference in its entirety.

### BACKGROUND OF THE INVENTION

### Field of the Invention

The present invention relates to a method for producing an earpiece of a hearing apparatus to be inserted into an auditory canal by selecting a virtual raw vent and manufacturing the earpiece with a real vent. The term hearing apparatus is understood here to mean any auditory stimulus-producing device which can be worn in or on the ear, in particular a hearing device, a headset, earphones or the like.

Hearing devices are wearable hearing apparatuses which are used to provide hearing assistance to the hard-of-hearing. In order to accommodate the numerous individual requirements, various designs of hearing devices are available such as behind-the-ear (BTE) hearing devices, hearing device with external earpiece (RIC: receiver in the canal) and in-the-ear (ITE) hearing devices, for example also concha hearing devices or completely-in-the-canal (ITE, CIC) hearing devices. The hearing devices listed as examples are worn on the outer ear or in the auditory canal. Bone conduction hearing aids, implantable or vibrotactile hearing aids are also available on the market. With these devices the damaged hearing is stimulated either mechanically or electrically.

The key components of hearing devices are principally an input transducer, an amplifier and an output transducer. The input transducer is normally a sound receiver e.g. a microphone and/or an electromagnetic receiver, e.g. an induction coil. The output transducer is most frequently realized as an electroacoustic transducer, e.g. a miniature loudspeaker, or as an electromechanical transducer, e.g. a bone conduction receiver. The amplifier is usually integrated into a signal processing unit. This basic configuration is illustrated in FIG. 1 using the example of a behind-the-ear hearing device. One or more microphones 2 for picking up ambient sound are incorporated into a hearing device housing 1 to be worn behind the ear. A signal processing unit (SPU) 3 which is also integrated into the hearing device housing 1 processes and amplifies the microphone signals. The output signal from the signal processing unit 3 is transmitted to a loudspeaker or receiver 4, which outputs an acoustic signal. The sound may be transmitted to the device wearer's eardrum by way of an acoustic tube which is fixed in the auditory canal by means of an earmold. Power for the hearing device and in particular for the signal processing unit 3 is supplied by means of a battery (BAT) 5 which is also integrated in the hearing device housing 1.

A vent is in many cases an essential component of a hearing device or earmold piece. The vent is used to ventilate the space in the auditory canal between the eardrum and the hearing device shell and/or the earmold piece. If the vent is too large, this results in amplified feedback. If the vent is by contrast too small, occlusion effects may occur. An optimal vent therefore represents a corresponding compromise.

With the aid of adjustment software, a hearing device can be adjusted to the hearing impairment and/or hearing ability of a user. With this adjustment software, the acoustic behavior of a hearing device including the vent can be simulated. With the simulation, a vent with a round cross-section is assumed. It is nevertheless in most instances not certain that a round, simulated vent of this type fits into the earmold piece and/or the hearing device shell. If, however, a deviation from the simulated form occurs when manufacturing the earmold piece and/or the hearing device shell, the acoustic behavior of the hearing apparatus also changes with respect to the simulated behavior.

The manufacturing method of an earpiece (e.g. earmold piece or hearing device shell) with a vent was previously designed as follows: a round vent was initially selected, for instance by means of the adjustment software. An attempt was then made to fit this round vent into the earpiece. If it did not fit into the shell, another design of the vent was attempted.

A few problems nevertheless resulted therefrom. The vent length was on the one hand not taken into consideration. The vent length nevertheless influences the acoustic mass of the vent and thus its base frequency in the transmission behavior.

A further problem consisted in that the resulting vent, whether it is round or shaped otherwise, exhibited an undefined acoustic mass depending on the shape. It was not guaranteed that the acoustic mass of the real vent agreed exactly with the acoustic mass of the vent simulated in the adjustment software. This often resulted in disagreeable surprises if the hearing apparatus was inserted into the ear of the patient. The hearing apparatus behaved acoustically different than during the simulation. This is because many hearing device dealers previously used no device simulation.

A method for producing a hearing device with an individually manufactured otoplastic is described in international patent application WO 2009/068696 A2 and its counterpart U.S. 2011/0258839 A1. The otoplastic is modeled with the aid of input data if necessary on the basis of a database. This model is sent to a manufacturer, where the otoplastic is manufactured correspondingly.

Furthermore, U.S. Patent Application Publication U.S. 2008/0300703 A1 describes a hearing device with an embedded vent channel. The production method described there is based on a computer model, with which the acoustic properties of a vent can be simulated. Optionally, the computer model is based on the acoustic impedance.

### SUMMARY OF THE INVENTION

It is accordingly an object of the invention to provide a method of producing an ear piece with a vent which overcomes various disadvantages of the heretofore-known devices and methods of this general type and which provides for a method with which earpieces of hearing apparatus can be produced more reliably in respect of predetermined vent properties.

With the foregoing and other objects in view there is provided, in accordance with the invention, a method of producing an earpiece of a hearing apparatus to be inserted into an auditory canal, the method which comprises:

selecting a virtual raw vent;

determining a base frequency of an acoustic transmission function of the virtual raw vent;

determining a virtual vent as a function of the base frequency and of at least one predetermined property of the auditory canal or of the earpiece; and

manufacturing the earpiece with a real vent on a basis of the virtual vent.

In other words, according to the invention, the above and other objects are achieved by a method for producing an earpiece of a hearing apparatus to be inserted into an auditory canal by selecting a virtual raw vent and manufacturing the earpiece with a real vent, and determining a base frequency of the acoustic transmission function of the virtual raw vent and determining a virtual vent as a function of the base frequency and of at least a predetermined property of the auditory canal or of the earpiece, wherein the earpiece is manufactured on the basis of the virtual vent.

An acoustic variable, namely the base frequency of the acoustic transmission function of the virtual raw vent, is thus advantageously used as the basis for manufacture. It is initially not necessary here to know the final design of the real vent. Instead, this is determined with the aid of the base frequency and with the aid of geometric factors of the auditory canal and/or of the hearing apparatus. Since the real vent ultimately has the originally ascertained base frequency, it has known acoustic properties.

The virtual raw vent preferably has a circular cross-section. This is advantageous in that a simple geometry can be assumed during the simulation and the acoustician does not need to give any thought to the geometry of the vent during the adjustment process.

It is furthermore advantageous if the virtual raw vent is selected by means of adjustment software for adjusting the hearing apparatus to a hearing ability of the user. The acoustic properties of the vent can thus be mutually simulated together with the other acoustic properties of the hearing apparatus.

Instead of the base frequency, the acoustic mass of the virtual raw vent can be determined and the virtual vent can be obtained as a function of the acoustic mass. The base frequency of a tube-type vent can namely be clearly assigned to an acoustic mass or vice versa.

The at least one predetermined property of the earpiece can be the location or the course of the virtual vent in the earpiece. The positioning and the course of the virtual vent can thus be immediately taken into consideration in the geometric design of the vent.

When determining the virtual vent, according to one embodi-ment, one of several predetermined vent geometries can be selected automatically or semi-automatically with the aid of the base frequency. Predetermined geometries of this type are advantageous in that an actually realizable geometry of the vent can be found relatively quickly.

According to a particular embodiment of the inventive method, data relating to the virtual and/or real vent can be stored in the hearing apparatus. This is advantageous in that data relating to the vent is always available for subsequent applications.

In particular, data relating to the vent can thus be used by the adjustment software for adjustment to a hearing ability of the user. The vent data can be easily read out from the earpiece and/or the hearing apparatus and an acoustic variable which can be used immediately for the adjustment software (base frequency or acoustic mass) is available for adjustment purposes.

As already indicated, the earpiece can be an earmold piece and/or an otoplastic. Earmold pieces of this type are individually adjusted to the auditory canal so that a vent solution is provided in order to prevent occlusion effects.

The hearing apparatus may for instance also be an ITE hearing device and the earpiece may be the shell of the ITE hearing device. ITE hearing devices with an acoustically defined vent can thus also be produced.

Other features which are considered as characteristic for the invention are set forth in the appended claims.

Although the invention is illustrated and described herein as embodied in a method for producing an earpiece with vent, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows the basic structure of a hearing device according to the prior art; and

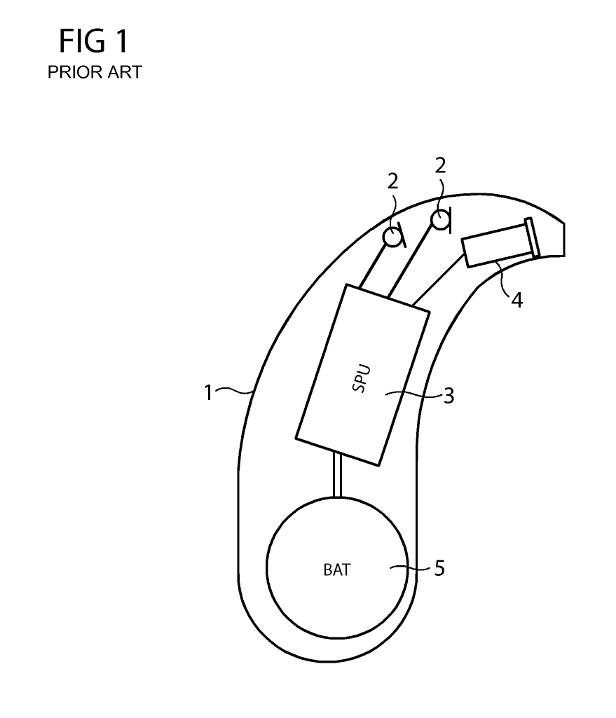

FIG. 2 is a flowchart illustrating a manufacturing process according to the present invention.

### DETAILED DESCRIPTION OF THE INVENTION

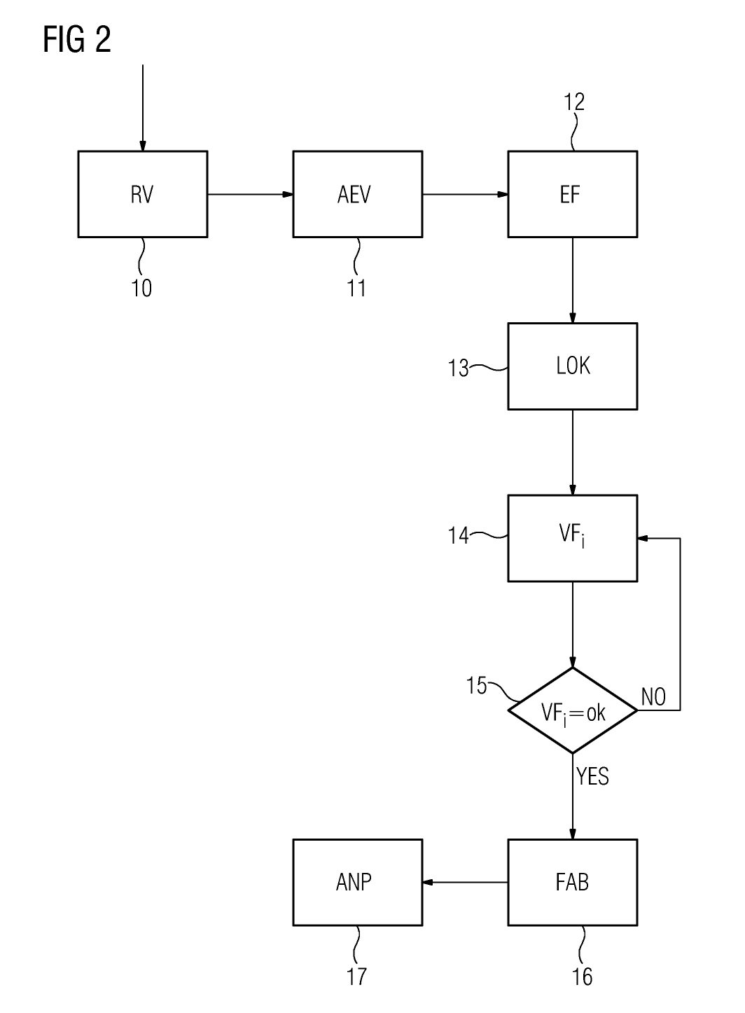

Referring now FIG. 2 of the drawing in detail there is shown a sequence according to which a hearing apparatus and in particular a hearing device can be produced with a vent for ventilation purposes. A sequence of this type is also sometimes suited to producing the earpiece, i.e. an earpiece or an ITE hearing device shell, of a hearing apparatus.

In a first step 10, a hearing device acoustician selects, using adjustment software for instance, a suitable vent for a hearing device of a patient and/or user. A virtual raw vent RV is selected in this way. A virtual raw vent of this type is formed, for instance, with a simple round cross-section. The diameter and the length of the raw vent can be defined by the adjustment software. With the thus defined virtual raw vent, an acoustic simulation of a corresponding hearing apparatus can be realized.

The geometry of the round raw vent is established at the end of the simulation. Since however the acoustician does not know whether a round vent of this type can be built into the hearing apparatus, he/she provides the manufacturer of the hearing apparatus with an order with an acoustically equivalent vent AEV according to step 11. The geometry data (if necessary only the diameter of the raw vent) of the originally round raw vent RV is used as the basis of this acoustically equivalent vent. This order of the hearing apparatus with the acoustically equivalent vent can be carried out by the acoustician with the aid of ordering software for instance.

The manufacturer receives the order with the acoustically equivalent vent AEV. This order is entered into a shell modeling software for instance. This calculates a base frequency EF of the acoustic transmission function of the virtual raw vent from the geometry data of the raw vent. If to this end only the diameter of the raw vent exists for instance, the shell modeling software is based for instance on an average shell length, which then determines the length of the vent. If the length of the raw vent is available, the base frequency EF in step 12 can be calculated correspondingly more accurately.

Instead of the base frequency, the shell modeling software can for instance also obtain another acoustic variable, such as the acoustic mass, from the geometry data of the raw vent. In this instance, further production can then take place with the aid of the acoustic mass of the vent space instead of the base frequency of the vent. Base frequency and acoustic mass can be transferred into one another in a known manner.

Furthermore, the shell modeling software in a step 13 automatically or semi-automatically determines the location LOK of the vent in the shell and/or the earpiece. The course (in other words the entire geometric location) of the vent within the shell or the earpiece is understood here by the term “location”.

With the location LOK (if necessary including course) and the base frequency EF (alternatively also acoustic mass), the shell modeling software then performs an iteration loop with the iteration variables i.

With the iteration loop, a virtual vent should be formed on the basis of the base frequency EF and the desired location LOK in or on the earpiece. To this end, a plurality of vent forms VFi is provided for instance in step 14 by a database. In this step, a virtual vent is then formed with a first vent shape VF1 for the specific base frequency and the selected location. In a subsequent step 15, a check is made to determine whether the virtual modeled vent fits into/onto the earpiece. If the virtual vent does not fit (NO), i.e. the first vent shape VF1 is therefore not ok, step 14 is reverted to and the next vent shape is then checked. This is repeated until a suitable vent shape VFi is found in step 15 (YES). A virtual vent is thus determined, which is based on the desired base frequency EF and is located at the desired location LOK in/on the earpiece.

The data of the virtual vent is now used in step 16 for fabrication purposes FAB, in order to produce a real earpiece with a real vent. If necessary, the data of the determined virtual vent, which geometrically corresponds to the real vent, is stored in a memory of the hearing apparatus. The earpiece or the entire hearing apparatus is then supplied to the acoustician.

In step 17, the real hearing apparatus is connected at the acoustician's to the adjustment software ANP, with which the raw vent was already selected in step 10. The adjustment software ANP then reads out the vent data stored in the hearing apparatus and identifies that a real vent is present, which is acoustically equivalent to the round vent with the diameter ordered by the acoustician. A high-quality adjustment can thus take place, which also takes into account the original acoustic specifications of the acoustician in the first simulation (step 10).

In the above example, the method steps are in most instances automatically represented by a software. The one or other step can however also be implemented manually with manual assistance.

Advantageously an earpiece for a hearing apparatus with a vent, which exhibits predetermined acoustic properties, can be reliably manufactured in an automated process. In summary, a base frequency-based vent selection is to this end found for instance in an adjustment software. The hearing apparatus and/or the earpiece is ordered with an acoustically equivalent vent. The vent is rejected in the above example by a shell modeling software according to the required base frequency and/or acoustic mass of the vent. If necessary, information relating to the integrated vent (acoustic mass or base frequency) is stored in the hearing apparatus. This information is finally read out from the hearing apparatus by the adjustment software and is used for the correct programming of the hearing apparatus.

The vent simulation in the simulation software (e.g. adjustment software) is therefore linked to the actually integrated vent by way of the base frequency and/or the acoustic mass. The final adjustment or tuning can then be improved in that information relating to the actually integrated vent is stored in the hearing apparatus for the adjustment process.

1. A method of producing an earpiece of a hearing apparatus to be inserted into an auditory canal, the method which comprises:
selecting a virtual raw vent;
determining a base frequency of an acoustic transmission function of the virtual raw vent;
determining a virtual vent as a function of the base frequency and of at least one predetermined property of the auditory canal or of the earpiece; and
manufacturing the earpiece with a real vent on a basis of the virtual vent.

2. The method according to claim 1, wherein the virtual raw vent is selected with a circular cross-section.

3. The method according to claim 1, which comprises selecting the virtual raw vent with adjustment software for adjusting the hearing apparatus to a hearing ability of a user.

4. The method according to claim 3, which comprises inputting data relating to the vent and using the data by the adjustment software to adjust to the hearing ability of a user.

5. The method according to claim 1, which comprises substituting a determination of an acoustic mass of the virtual raw vent for a determination of the base frequency, and defining the virtual vent in dependence on the acoustic mass.

6. The method according to claim 1, wherein the at least one predetermined property of the ear-piece is the location or the course of the virtual vent in the earpiece.

7. The method according to claim 1, which comprises, after the virtual vent has been determined, selecting one of a plurality of predetermined vent geometries automatically or semi-automatically with the aid of the base frequency.

8. The method according to claim 1, which comprises storing data relating to at least one of the virtual vent or the real vent in the hearing apparatus.

9. The method according to claim 8, which comprises using the data relating to the vent by the adjustment software to adjust to a hearing ability of a user.

10. The method according to claim 1, wherein the earpiece is an earmold piece.

11. The method according to claim 1, wherein the hearing apparatus is an ITE hearing device and the earpiece is a shell of the ITE hearing device.
